(19) United States
(12) Patent Application Publication
(10) Pub. No.: US 2011/0026778 A1
(43) Pub. Date: Feb. 3, 2011

(54) System and Method of Using Facial Recognition to Update a Personal Contact List

(75) Inventor: Minhua Ye, Beijing (CN)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/562,686

(22) Filed: Sep. 18, 2009

(30) Foreign Application Priority Data
Jul. 30, 2009 (CN) 200910166991.X

(51) Int. Cl. G06K 9/00

(52) U.S. Cl. 382/118

(57) ABSTRACT

An electronic device has a memory that stores images of people and a contact list of personal contacts. Each personal contact is a record that identifies the contact information for a person, and a corresponding facial signature for the person. The facial signature identifies a unique facial pattern for that person. The device analyzes the facial features of the person in the image and extracts selected facial features for comparison to the facial signatures in the contact list. Based on the results of the comparison, the device will link the image to the contact information.

### RELATED APPLICATION

This application claims the benefit of Chinese Application Number 200910166991.X, filed in China on Jul. 30, 2009. That application, which is entitled “Method of Using Facial Recognition to Update a Personal Contact List,” is incorporated herein by reference in its entirety.

### BACKGROUND

The present invention relates generally to communications devices, and particularly to communication devices having personal contact lists that identify one or more personal contacts for a user.

Many communication devices, such as cellular telephones, for example, allow a user to store a plurality of captured images. The images may include images of places or things, but will generally also include images of the user's friends and family. To view these images, the user must typically navigate multiple levels of a hierarchical menu. Once a particular image is located, the user can select the image filename to view the image on the display.

Additionally, many of these same devices also employ a contact list. A contact list is a list in memory that allows a user to store and organize contact information for his or her personal contacts. The contact information typically includes the names of the user's friends and family, and one or more telephone numbers where they may be reached. In most instances, the contact information also includes email addresses for the contacts. To view the contact information, the user typically navigates another hierarchical menu on the device until he or she reaches a desired contact. Then, the user can select the contact's name to display the contact information for that person.

Currently, users must browse many different images to locate an image of a particular person, or to locate all the images in which that person appears. Additionally, users must navigate multiple levels of a hierarchical menu simply to retrieve the contact information for that particular person. Conventional communication devices do not allow users to correlate the contact information for a given person to one or more images in which that person appears.

### SUMMARY

The present invention provides a communication device that employs facial recognition techniques to generate a bi-directional index that links a person's contact information stored in a user's contact list to one or more images in which that person appears. Particularly, the device analyzes the faces of people in the images and then uses those results to locate their corresponding contact information in a contact list. Once found, the device updates the contact list by linking the filenames of the images in which a given person appears to that person's contact information. For example, an image list may be associated with each contact in the contact list. The image list functions as a bi-directional index by allowing users to view all of the images of a specific person without having to locate and open each of the images. In addition, it allows a user to view a person's contact information simply by viewing an image of the person.

In one embodiment, the present invention provides an electronic communication device comprising a memory to store a contact list including contact information, and corresponding facial signatures, for one or more personal contacts, and a controller. The controller is programmed to analyze an image to extract selected facial features identifying a person appearing in the image, compare the selected facial features of the person appearing in the image with the facial signatures in the contact list, and link the image being analyzed with the contact information of a person in the image based on the results of the comparison.

In one embodiment, the controller is further programmed to locate the person's face in the image.

In another embodiment, the controller is programmed to link the filename of the image being analyzed to the contact information of the person in the image if the selected facial features extracted from the image match the facial signature of the person.

The controller is also programmed to remove the link when the image is deleted from memory.

The device may also comprise a display to display an image to a user. In this embodiment, the controller determines whether a cursor on the display is positioned over the person appearing in the displayed image, and retrieves the contact information from the contact list for the person appearing in the image based on the results of the comparison. The device then overlays the displayed image with the contact information.

In one embodiment, the controller is further programmed to display the contact information as hyperlinks that can be selected by the user. One or more of the links initiate communications with the person appearing in the image when selected by the user. One or more of the links may also launch additional images of the person appearing in the analyzed image.

In another embodiment, the present invention provides a method of linking the contact information in a user's personal contact list to one or more images. Particularly, the method stores a contact list in memory of a communication device. The contact list includes contact information and corresponding facial signatures for one or more personal contacts. The method then analyzes an image to extract selected facial features of a person appearing in the image, and compares the selected facial features extracted from the image with the facial signatures stored in the contact list. The method then links the image being analyzed with the contact information of a person in the image based on the results of the comparison.

In one embodiment, analyzing an image to extract selected facial features of a person appearing in the image comprises processing the image to locate the person's face in the image.

In one embodiment, linking the image comprises linking the filename of the image being analyzed to the contact information of a person appearing in the image if the selected facial features match the facial signature of the person.

In one embodiment, the method further comprises deleting the link responsive to the file being deleted from memory.

In another embodiment, the present invention displays the image to the user and detects whether a cursor on the display is positioned over the person appearing in the displayed image. If so, the present invention retrieves contact information from the contact list for the person appearing in the image based on the results of the comparison, and overlays the displayed image with the contact information.

In one embodiment, the contact information is displayed as one or more hyperlinks that can be selected by the user. Selecting one or more of the links can establish a communications link with the person appearing in the image. Similarly, selecting another link can display one or more additional images of the person for the user.

### BRIEF DESCRIPTION OF THE DRAWINGS

FIG. 1 is a block diagram illustrating some of the components of a communication device configured to function according to one embodiment of the present invention.

FIG. 2 illustrates contact information stored in an exemplary contact list according to one embodiment of the present invention.

FIGS. 3A-3B are flow charts illustrating methods by which a contact list may be updated according to one embodiment of the present invention.

FIG. 4 illustrates a communication device configured to operate according to one embodiment of the present invention.

FIG. 5 illustrates how the contact information and the images may be linked according to one embodiment of the present invention.

FIG. 6 is a flow chart illustrating a method by which a communication device displays the contact information for a person in an image according to one embodiment of the present invention.

FIG. 7 is a perspective view illustrating other types of communication devices that may be configured to operate according to one embodiment of the present invention.

### DETAILED DESCRIPTION

The present invention provides a communication device that links a person's contact information to one or more images of that person. Particularly, the device employs a facial recognition technique to analyze the face of a person in an image and extract a set of facial features. The device then uses those extracted facial features to determine which of the people in the contact list appear in the image, and links the image to the corresponding entries in the user's contact list.

Linking the images to a person's contact information according to the present invention provides benefits not realized by conventional devices. For example, the contact information for a particular person will identify all the images in which that person appears. This allows users to easily view or recall an image of that person directly from the contact list, and negates the need to browse through many images to locate every image of that person. Linking also allows the user to view the contact information for a particular person in an image without having to independently launch, and search through, the contact list for that person. Particularly, the user needs simply to place a cursor over the person's face in the image while viewing the image. The device will then retrieve the contact information for that person from the contact list, and display the contact information as an overlay.

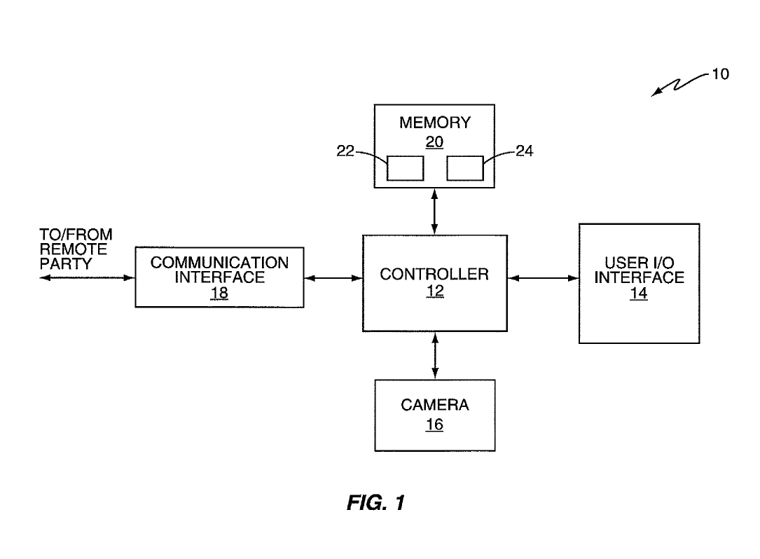

FIG. 1 is a block diagram illustrating some of the components of a communication device 10 configured to operate according to one embodiment of the present invention. Device 10, which in this embodiment is a camera-equipped cellular telephone, comprises a programmable controller 12, a user input/output interface 14, a camera 16, a communications interface 18, and a memory 20. As described in more detail later, memory 20 stores a contact list 22 that organizes the contact information for a plurality of contacts, such as the user's family and friends, and one or more images 24 that contain the faces of the people in the contact list 22.

Controller 12 generally controls the overall operation of device 100 according to programs and instructions stored in memory 20. The controller 12, which may be implemented in hardware, firmware, software, or a combination thereof, may comprise a single microprocessor or multiple microprocessors. The microprocessors may be general purpose microprocessors, digital signal processors, or other special purpose processors. Some exemplary functions performed by controller 12 include, but are not limited to, audio processing and image processing. As discussed in greater detail below, the controller 12 is programmed to analyze the images 24 stored in memory 20 to determine which people in the contact list 22 appear in which images 24. Based on that analysis, the controller 12 is programmed to link the images 24 with the corresponding entries in the contact list 22.

The User Interface (UI) 14 includes one or more user input devices and a display. The UI 14 enables the user to interact with and control the device 10, and may include input devices such as a keypad, touchpad, joystick control dials, control buttons, or a combination thereof. Other devices are also possible. For example, one embodiment of the present invention employs a touch-sensitive display as the UI 14. As is seen in more detail later, the display allows the user to view images 24 of a particular person in the contact list 22, as well as an overlay of that person's contact information.

The camera 16 is a fully functional digital camera device that allows the user to capture digital images and/or video. When capturing the images or audio, the display functions as a viewfinder. In accordance with the present invention, the user may capture digital images of a person in the contact list 22, and store the images in memory 20. The controller 12 may then analyze these images 24 and link them to the appropriate person in the contact list 22.

The communication interface 18 allows the device 10 to communicate with one or more remote parties. In this embodiment, the communication interface 18 comprises a fully functional cellular radio transceiver that can operate according to any known standard, including the standards known generally as the Global System for Mobile Communications (GSM), cdma2000, Universal Mobile Telecommunications System (UMTS), Wideband Code Division Multiple Access (CDMA), 3GPP Long Term Evolution (LTE), and Worldwide Interoperability for Microwave Access (WiMAX). In other embodiments, however, the communication interface 18 may comprise a hardware port, such as an Ethernet port, for example, that connects device 10 to a packet data communications network. In yet another embodiment, the communication interface 18 may comprise a wireless LAN (802.11x) interface.

Memory 20 comprises a computer-readable medium that may include both random access memory (RAM) and read-only memory (ROM). Computer program instructions and data required for operation are stored in non-volatile memory, such as EPROM, EEPROM, and/or flash memory, which may be implemented as discrete devices, stacked devices, or integrated with the controller 12. As previously stated, memory 20 stores a contact list 22 that allows the user to organize the contact information for one or more personal contacts, such as the user's friends and family. The memory 20 also stores a plurality of images 24. If a contact in the contact list 22 appears in an image, the controller 12 is programmed to link that image to the corresponding entry in the contact list 22.

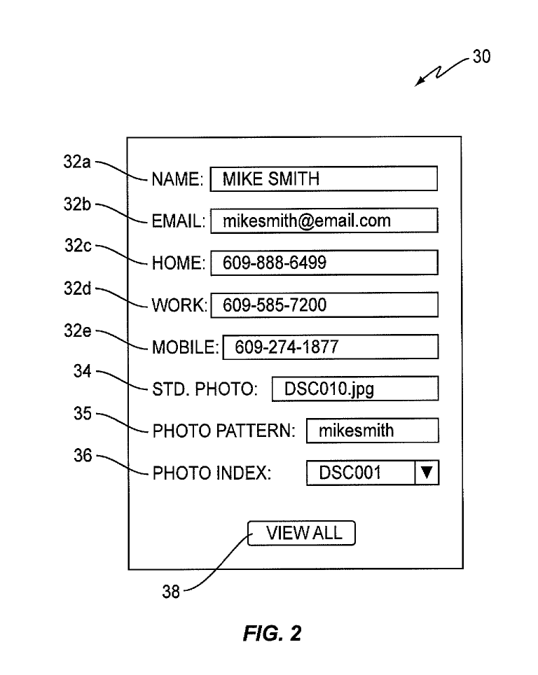

FIG. 2 illustrates some of the contact information 30 that may be stored for a given person in the contact list 22 according to the present invention. As is conventional, the contact information 30 includes a variety of fields for the person's name 32a, email address 32b, and home, work, and mobile telephone numbers 32c-32e. Other fields for other information may also be included; however, in this embodiment of the present invention, the contact information 30 also a standard image field 34, a facial signature field 35, and an image index field 36.

The standard image field 34 holds a filename identifying an image of the person's face. In this case, the image would include the face of “Mike Smith” and may be displayed, for example, when the user receives an incoming call from Mike Smith. In such cases, the image would function as a caller ID to identify the caller to the user. However, according to the present embodiment, this filename also identifies the image from which the controller 12 generates the person's facial signature. Particularly, the controller 12 performs a facial recognition analysis on the image identified in the standard image field 34. The results of the analysis identify a set of facial features that will serve as the facial signature of the person. The results or artifacts are then saved to a file, which in this embodiment is named “mikesmith.” Subsequent image analysis performed on one or more of the images 24 stored in memory 20 produce similar sets of facial features that are compared against this facial signature. The filenames of those images producing sets of facial features that match the facial signature (i.e., those images in which Mike Smith appears) appear in a list in the image index field 36. The image index field 36 may be any type of control that is able to display identifiers that identify one or more images; however, in this embodiment, the image index field 36 comprises a list box or combo box that displays the filenames of the images.

As stated above, the present invention negates the need for a user to browse through multiple images to view those of a specific person. To that end, the controller 12 formats the filenames of the images in the standard image field 34 and the image index field 36 as hyperlinks. The files listed in the contact information 30 identify only those images in which that person appears. Thus, when the user views the contact information 30 for that person, the user has immediate access to all the images of that person. The user must simply select or “click” on one of the filenames to view the corresponding image. The images 24 could be saved in memory 20 as JPEG files, for example, or as some other file type having a well-known format. Therefore, when the user clicks on a desired filename, the controller 12 could launch a commercially available viewer application to display the corresponding image to the user. To view all images, the user may actuate or “click” a button control 38 to open all images for display to the user in an image browser.

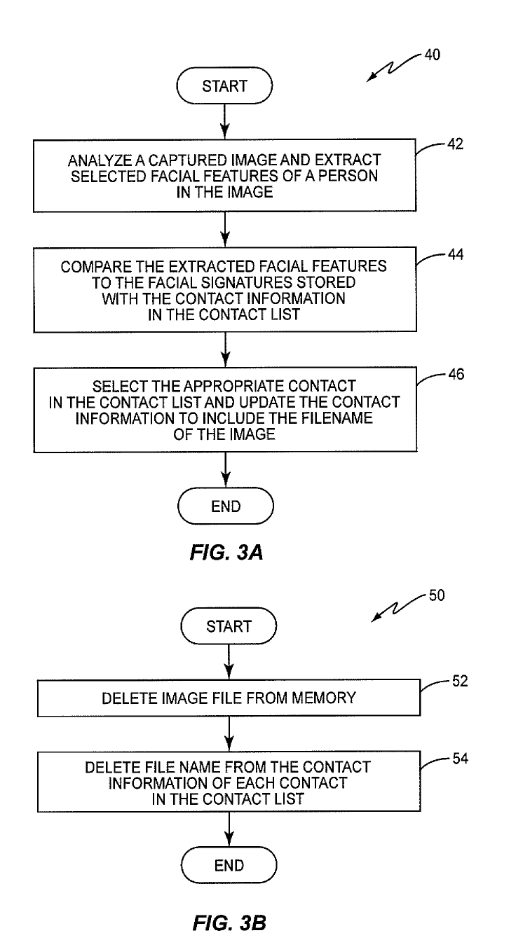

FIGS. 3A and 3B are flow diagrams illustrating methods 40, 50 by which the present invention updates the contact information 30 in the contact list 22 using facial recognition analysis. As seen in FIG. 3A, method 40 begins when the controller 12 analyzes a visual image of an individual using a facial recognition technique to extract the facial features of a person in the image (box 42). Generally, the captured image is already a digital image; however, if it is not a digital image, an analog-to-digital conversion may be performed on the image to generate a digital representation of the image. Such analog-to-digital conversion may be performed, for example, by circuitry in the camera 16 or by controller 12.

There are many ways in which the controller 12 may analyze the image, but in one embodiment, the controller 12 pre-processes the digital image to prepare the image for facial recognition analysis. Such pre-processing may include, but is not limited to, color correction, and adjustments to darkness and contrast. The purpose of the pre-processing is to generate a clean image to improve the accuracy of the facial recognition analysis. Alternatively, the camera 16 may include circuitry that performs the pre-processing of the image.

From the pre-processed image, the controller 12 executes a facial recognition algorithm to locate the person's face within the image, and extract the facial features of the person from the image. There are many known approaches to performing facial recognition. These include, but are not limited to, the Principal Component Analysis (PCA) approach (also known as eigenfaces), the Elastic Graph Matching (EGM), the Artificial Neural Networks, and the pseudo-2D Hidden Markov Models (HMM). Any of these techniques, or other similar techniques, may be used to perform the facial recognition analysis of the present invention.

Once the facial recognition analysis has been performed, the controller 12 compares the extracted facial features with the facial signatures stored in the contact list 22 in memory 20 to determine whether the person in the image is also in the user's contact list (box 44). As with the facial recognition, there are many ways in which controller 12 can be programmed to perform the determination. However, in this embodiment, the controller 12 may need to first normalize the image. The controller 12 then executes a comparison algorithm that compares the extracted facial features to the facial signatures, and generates a score value that ranks those facial signatures that best match the facial features extracted from the captured image. The controller 12 then automatically selects the most appropriate facial signature as a match for the person in the image and updates the contact information 30 for that person. Particularly, the controller 12 adds the filename of the analyzed image to a list of images in the person's contact information (box 46).

Generally, the number of individuals in the contact list 22 is small. As such, known facial recognition and analysis processes may be modified to improve speed. For example, the controller 12 may extract smaller sets of facial features from the images to speed processing. Using smaller facial feature sets may reduce the accuracy with which the controller 12 can identify a given individual in an image, and/or successfully match that individual to a specific person in the contact list 22. However, these smaller sets of facial features may still be sufficient with which to match the person in the image to that person's corresponding contact information. For example, the controller 12 may narrow a field of people in the contact list 22 to a small number of possible candidates, and then allow the user to manually select which person is the correct person.

FIG. 3B is a flow diagram illustrating one method 50 in which the contact list 22 is updated to remove the filenames of images that are deleted by the user from memory 20. Method 50 begins when the user deletes a given image from those images 24 stored in memory 20 (box 52). Upon detecting that the image file has been deleted, the controller 12 retrieves the contact list 22. For each person in the contact list 22 having the filename of the deleted image in their contact information 30, the controller 12 will delete the corresponding link (box 54).

As previously stated, the link connecting the images 24 and the contact list 22 functions as a bi-directional index. It allows a user to view all images of a particular person simply by locating the person's contact information 30 in contact list 22. It also allows the user to view the contact information 30 for a person that appears in an image being displayed to the user without requiring the user to independently open a contact list 22 to search for and locate that person.

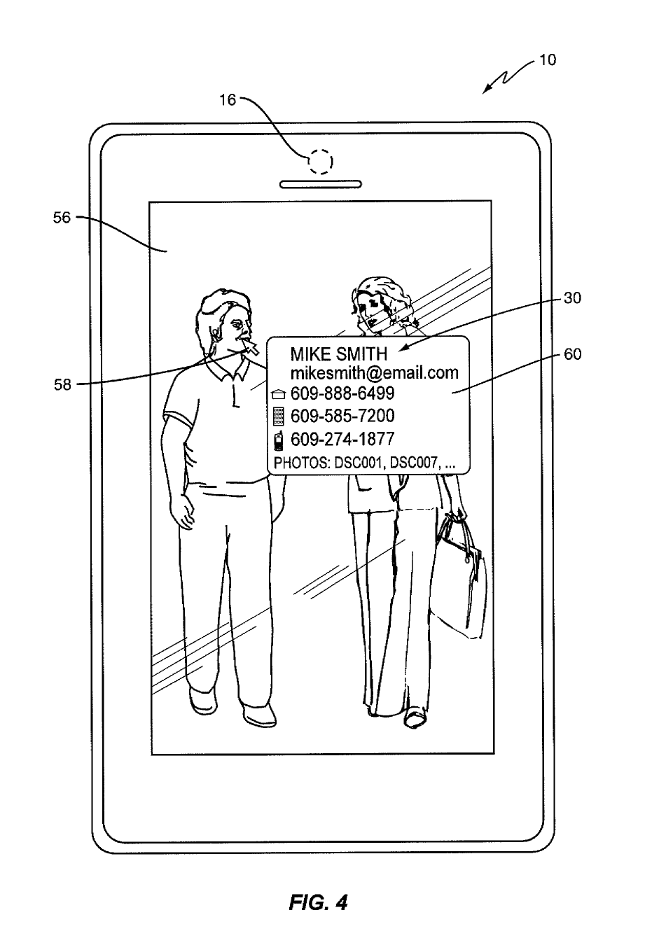

FIG. 4 is a perspective view of device 10 in which an image is displayed on a display 56. The image shows two people. When the user moves a cursor 58 over one of the people in the image, controller 12 determines the identity of that person and retrieves that person's contact information 30 from the contact list 22. The controller 12 then displays that information in a translucent overlay 60 for the user. The controller 12 may format the contact information 30 as a hyperlink, for example, allowing the user to initiate an action simply by selecting the appropriate link. Thus, by way of example, if the user wishes to call the person in the image at home, the user would need only to select the home phone information link from the overlay 60. Similarly, if the user wishes to send that person an email, the user would simply select the link identifying the person's email address. Doing so would launch an email program resident on the device 10 so that the user could compose and send the email to the user. In the same manner, the user could view other images of that person by selecting the link for a desired image in the overlay 60. Thus, with the present invention, the user does not need to lookup the contact information 30 in a contact list 22 for a specific person shown in an image.

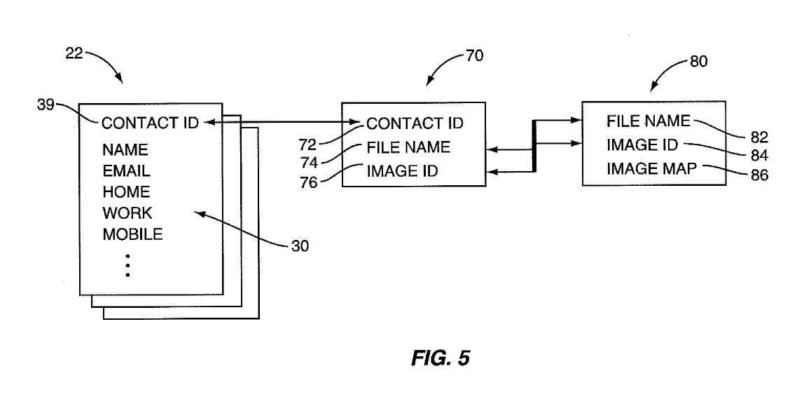

FIG. 5 illustrates how the bi-directional linking may be implemented in one embodiment of the present invention. In this embodiment, a linking table 70 is stored in memory 20 along with the contact list 22 and an image table 80 that stores information about the images 24 in memory 20. The linking table 70 is used to link the contact information 30 of a particular person in the contact list 22 to one or more entries in the image table 80. The linking table 70 also links each entry in the image table 80 to the contact information 30 for a particular person.

In more detail, a contact ID field 39 that contains a unique identifier is part of the contact information 30 for each entry in the contact list 22. The controller 12 typically generates this identifier when adding a contact to the contact list 22 to uniquely identify a given entry in the contact list 22. The linking table 70 includes a corresponding contact ID field 72, a filename field 74 to store the name of the image file, and an image ID field 76. The image ID field 76 is an arbitrary value assigned to each person appearing in a single image, and thus, is used to distinguish between multiple people appearing in a single image. For example, a first person appearing in an image might be assigned a “1,” while a second person appearing in the image might be assigned a “2.”

The image table 80 contains information associated with each image. Each entry includes a corresponding filename field 82, a corresponding image ID field 84, and an image map field 86. Entries may be added and deleted whenever an image is added to, or deleted from, the memory 20. The filename field 82 stores the filename of the image, and the image ID field 84 stores the corresponding arbitrary image ID value described above. The image map field 86 stores the location of a “hot spot” that is associated with the person assigned the image ID value. The hot spot is used to generate the overlay 60 when the user places the cursor over that hot spot.

Particularly, each hot spot is a location comprising a region or portion of the overall image. The hot spot may be stored, for example, as pixel coordinates (i.e., (x₁, y₁), (x₂, y₁), (x₁, y₂), (x₂, y₂)) in the image map field 86. Such coordinates define the corners of a box that is large enough to substantially frame some portion of a person appearing in the image, such as the person's face. Whenever the user moves the cursor into one of these defined regions while viewing an image, the controller 12 uses the information in the corresponding image table 80 to retrieve the corresponding contact information 30 from the contact list 22 for display to the user in overlay 60.

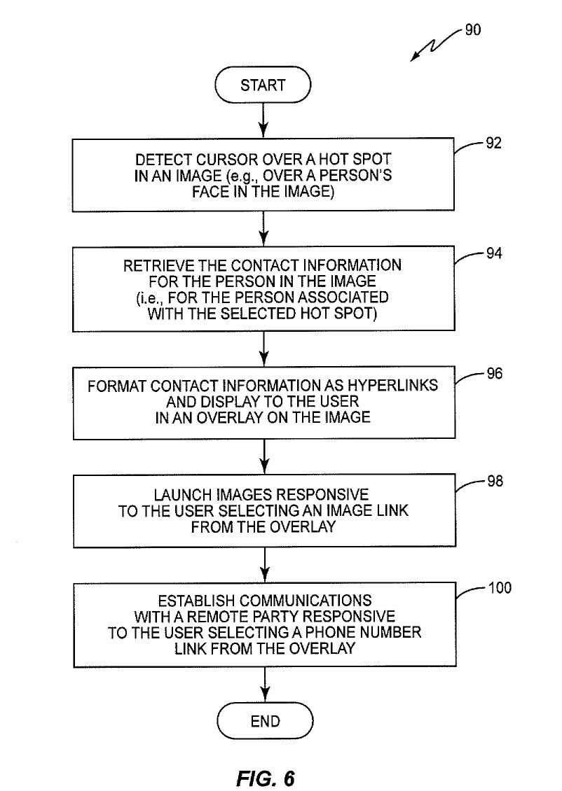

FIG. 6 is a flow diagram illustrating a method 90 of displaying the contact information for a particular person as an overlay on an image containing that person. Method 90 begins with the controller 12 detecting the position of the cursor 58 within a predefined region of the image (i.e., over one of the “hot spots” defined in the image map filed 86 for the image). There are many ways to detect the position of the cursor 58; however in this embodiment, an operating system monitors the relative display coordinates of the cursor 58 and periodically communicates them to the controller 12. The controller 12 then searches each entry in the image map table 80 having the same filename as the image being viewed. Once the entries are found, the controller 12 compares the reported coordinates with those stored in the image map fields 86 of the corresponding image table 80 entries. The controller 12 detects that the cursor 58 is positioned over a person's face in an image when the controller 12 determines that the reported coordinates are within one of the predefined regions (box 92).

Having found the correct image table 80 entry, the controller 12 will use that information to locate and retrieve the contact information 30 associated with that person (i.e., the person associated with the selected hot spot) (box 94). For example, in one embodiment, the controller 12 will extract the image ID field 84 from the image table 80 entry, and use it, along with the filename, as a unique index into the linking table 70 to determine the corresponding contact ID 72. The controller 12 then uses the contact ID 72 as an index into the contact list 22. If the person is found in the contact list 22 (i.e., the contact list has an entry with the corresponding contact ID), the controller 12 will retrieve the contact information 30 for that person. The controller 12 then formats the contact information 30 as hyperlinks and displays them in overlay 60 to the user (box 96). Responsive to the user selecting an image link, the controller will launch a viewer to display the selected image (box 98). Similarly, the controller 12 will establish a call with the person in the image responsive to the user selecting one of the telephone number links in the overlay 60 (box 100).

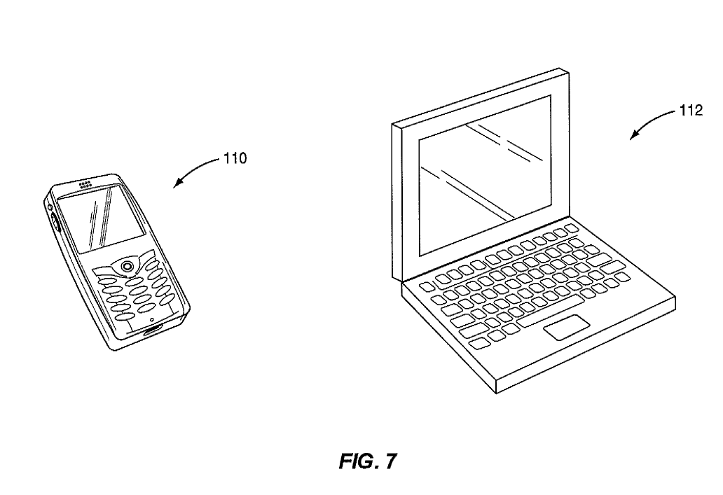

The present invention may, of course, be carried out in other ways than those specifically set forth herein without departing from essential characteristics of the invention. For example, the specification and drawings describe device 10 in terms of a camera-equipped cellular telephone. However, those skilled in the art should appreciate that the present invention is not limited solely to cellular telephones. FIG. 7 shows at least two other communication devices that are suitable for use according to the present invention. These include a Personal Digital Assistant (PDA) 110 and a laptop computing device 112. In either case, the device 110, 112 may be connected to a communication network and programmed to allow a user to update an address book, for example, based on images of the people in the address book. The devices 110, 112 may also be programmed to display the contact information for a specific person appearing in an image being displayed to the user as previously described. Other types of suitable device include, but are not limited to, satellite phones and desktop computers.

The present embodiments are to be considered in all respects as illustrative and not restrictive, and all changes coming within the meaning and equivalency range of the appended claims are intended to be embraced therein.

What is claimed is:

1. An electronic device comprising:
a memory configured to store a contact list including contact information, and corresponding facial signatures, for one or more personal contacts;
a controller programmed to:
analyze an image to extract selected facial features identifying a person appearing in the image;
compare the selected facial features of the person appearing in the image with the facial signatures in the contact list; and
link the image being analyzed with the contact information of a person in the image based on the results of the comparison.

2. The device of claim 1 wherein the controller is further programmed to locate the person's face in the image.

3. The device of claim 1 wherein the controller is programmed to link the filename of the image being analyzed to the contact information of the person in the image if the selected facial features extracted from the image match the facial signature of the person.

4. The device of claim 3 wherein the controller is further programmed to remove the link when the image is deleted from memory.

5. The device of claim 1 further comprising a display to display the image to a user, and wherein the controller is further programmed to;
determine whether a cursor on the display is positioned over the person appearing in the displayed image;
retrieve contact information from the contact list for the person appearing in the image based on the results of the comparison; and
overlay the displayed image with the contact information.

6. The device of claim 5 wherein the controller is further programmed to display the contact information as hyperlinks that can be selected by the user.

7. The device of claim 6 wherein one or more of the hyperlinks initiate communications with the person appearing in the image when selected by the user.

8. The device of claim 6 wherein one or more of the hyperlinks launch additional images of the person appearing in the analyzed image.

9. A method of linking contact information in a personal contact list to one or more images, the method comprising:
storing a contact list in memory of a communication device, wherein the contact list includes contact information and corresponding facial signatures for one or more personal contacts;
analyzing an image to extract selected facial features of a person appearing in the image;
comparing the selected facial features extracted from the image with the facial signatures stored in the contact list; and
linking the image being analyzed with the contact information of a person in the image based on the results of the comparison.

10. The method of claim 9 wherein analyzing an image to extract selected facial features of a person appearing in the image comprises processing the image to locate the person's face in the image.

11. The method of claim 9 wherein linking the image being analyzed comprises linking the filename of the image being analyzed to the contact information of a person appearing in the image if the selected facial features match the facial signature of the person.

12. The method of claim 11 further comprising deleting the link responsive to the file being deleted from memory.

13. The method of claim 9 further comprising:
displaying the image to the user;
detecting whether a cursor on the display is positioned over the person appearing in the displayed image; and
retrieving contact information from the contact list for the person appearing in the image based on the results of the comparison; and
overlaying the displayed image with the contact information.

14. The method of claim 13 further comprising formatting the contact information to be displayed as one or more hyperlinks that can be selected by the user.

15. The method of claim 14 further comprising establishing communications with the person appearing in the image responsive to the user selecting a link in the overlaid image.

16. The method of claim 14 further comprising displaying one or more additional images of the person responsive to the user selecting one or more of the links.
